(19) United States
(12) Patent Application Publication
(10) Pub. No.: US 2006/0291482 A1
(43) Pub. Date: Dec. 28, 2006

(54) Method and apparatus for providing a metropolitan mesh network

(75) Inventor: David Evans, Los Altos Hills, CA (US)

Correspondence Address: SIERRA PATENT GROUP, LTD., 1657 Hwy 395, Suite 202, Minden, NV, 89423, US

(73) Assignee: Cisco Technology, Inc.

(21) Appl. No.: 11/159,585

(22) Filed: Jun. 23, 2005

(51) Int. Cl. H04L 12/56

(52) U.S. Cl. 370/401; 370/406

(57) ABSTRACT

The present disclosure provides for creating a metropolitan mesh network using vehicles as the framework. Mobile access points are installed on vehicles and configured to create ad-hoc, self-healing networks using mesh technology.

### BACKGROUND

1. Field of the Disclosure

The disclosure relates generally to data communications, and in particular, to creating a mesh network in a metropolitan setting.

2. The Prior Art

While the reach of the Internet seems unlimited, currently only relatively small percentage of the world's population has access to the Internet. The relatively static development of phone systems and their associated access networks means that large areas may never have traditional terrestrial Internet access systems brought to their doorstep.

Wireless Internet access, commonly referred to as WiFi, has made inroads in bringing high speed Internet access to a new base of users. Industry groups such as the WiFi alliance estimate that between 25,000 and 30,000 public WiFi hotspots exist worldwide as of the filing of this disclosure. Typically, WiFi hotspots are provided as part of a business model, such as an Internet cafe, and thus are provided to attract customers. Hence, there is little incentive to install WiFi hotspots in locations where there is no related business.

### BRIEF DESCRIPTION OF THE DRAWING FIGURES

FIG. 1 is a conceptual block diagram of a metropolitan mesh network configured in accordance with the teachings of this disclosure.

FIG. 2 is a conceptual block diagram of a mobile router for use in a metropolitan mesh network configured in accordance with the teachings of this disclosure.

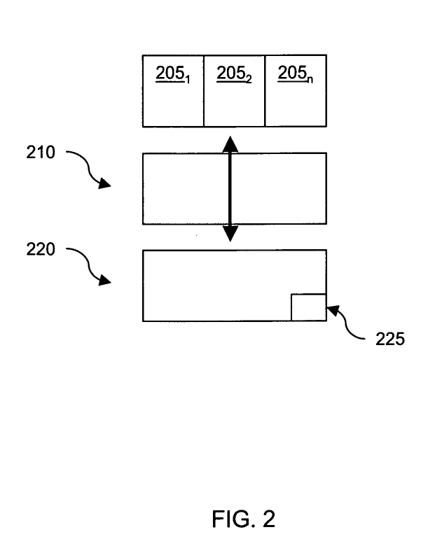

FIG. 3 is a conceptual block diagram of a metropolitan mesh network in operation in accordance with the teachings of this disclosure.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

This disclosure may relate to data communications. Various disclosed aspects may be embodied in various computer and machine readable data structures. Furthermore, it is contemplated that data structures embodying the teachings of the disclosure may be transmitted across computer and machine readable media, and through communications systems by use of standard protocols such as those used to enable the Internet and other computer networking standards.

The disclosure may relate to machine readable media on which are stored various aspects of the disclosure. It is contemplated that any media suitable for retrieving instructions is within the scope of the present disclosure. By way of example, such media may take the form of magnetic, optical, or semiconductor media, and may be configured to be accessible by a machine as is known in the art.

Various aspects of the disclosure may be described through the use of flowcharts. Often, a single instance of an aspect of the present disclosure may be shown. As is appreciated by those of ordinary skill in the art, however, the protocols, processes, and procedures described herein may be repeated continuously or as often as necessary to satisfy the needs described herein. Accordingly, the representation of various aspects of the present disclosure through the use of flowcharts should not be used to limit the scope of the present disclosure.

One aspect of increasing population density that has not been leveraged for Internet connectivity is the potential use of motor vehicles. It is contemplated that delivery vehicles, taxi cabs, and the like may be equipped with mobile access points to provide a pervasive high-speed Internet connection. For example, United Parcel Service has approximately 88,000 ground vehicles worldwide, while FedEx has approximately 48,000, and New York City has more than 12,000 taxi cabs.

The present disclosure provides for creating a metropolitan mesh network using vehicles as the framework. Mobile access points are installed on vehicles and configured to create ad-hoc, self-healing networks using mesh technology.

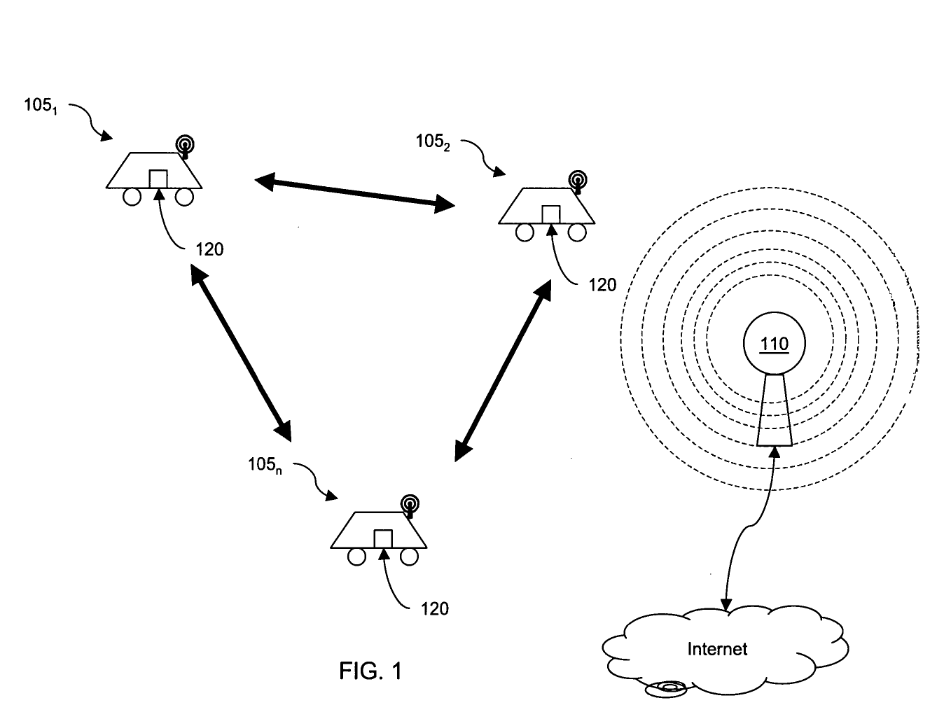

FIG. 1 is a block diagram of metropolitan mesh network 100 configured in accordance with the teachings of this disclosure. The system 100 includes one or more vehicles 105₁ . . . 105ₙ that are configured to form a mesh network as will be more fully described below. The vehicles 105 may communicate peer-to-peer in an ad-hoc fashion, or communicate through each other to reach a terrestrial wired access point 110 through which the Internet may be reached.

In the system 100 of FIG. 1, it is contemplated that each vehicle can function as a router, and hence the vehicles 105 form a wireless network where the vehicles themselves function as nodes. Thus, the vehicles themselves act as mobile nodes, i.e., no backbone infrastructure is required to form the network.

Thus, it is contemplated that the vehicles 105 of FIG. 1 are preferably configured to function as a collection or swarm of mobile nodes, dynamically forming a fluid network without the need for preexisting network infrastructure or centralized administration. The mobile nodes can be arbitrarily located and are free to move randomly at any given time in or out of the network. With no dedicated wired routers being necessary, each mobile node in network acts as a router and is responsible for discovering and maintaining routes to other nodes.

To function as a mobile node, each of the vehicles 105 includes a mobile router 120. The mobile router includes one or more communications modules 205₁ . . . 205ₙ for providing connectivity for the host vehicle. The communications modules preferably facilitate communication between the vehicle and the network, and between the user and the router.

To facilitate communication with the network, it is contemplated that the mobile router may include a communication module compliant with the IEEE 802.16 wireless specification, known as WiMax (Worldwide Interoperability for Microwave Access). WiMax offers high speed Internet service within a 30-mile range, compared to the 300-foot range of WiFi (802.11).

While WiFi can offer speeds of up to 54 Mbs, WiMax offers speed in the range of 70 to 250 Mbs. At the low end, that's the equivalent of supporting 1,250 users at dial-up speeds or 60 businesses with business-class broadband speeds.

In particular, the vehicles of this disclosure may be configured in accordance with the 802.16e specification, which enables mobile 802.16 clients. In a further preferred embodiment, the 802.16 communication module is configured for mesh networking, as is proposed in the 802.16f standard. The system of this disclosure may also utilize the QoS and better handoff capabilities as proposed in the 802.16g specification.

It is contemplated that other communications modules may be provided, for example 802.11, Bluetooth, infrared, Ethernet, or USB connectivity may be provided, as may cellular connectivity such as GSM and CDMA.

The mobile router may also be configured to seamlessly roam between networks. For example, the vehicle may be able to switch the connection from neighboring vehicle to another, from one 802 network type to another (such as from 802.11b to 802.16), and even from wired to 802.11 or 802.16 connections.

The mobile router also includes an interface module for data processing and translation between the various communication modules and the router core 220. The router 220 may include a processor and associated memory for operation.

To facilitate mobile routing, it is contemplated that the mobile router may be Mobile IP-compliant. Mobile IP is an open standard, defined by the Internet Engineering Task Force (TF) RFC 2002, that allows users to keep the same IP address, stay connected, and maintain ongoing applications while roaming between IP networks. Mobile IP is scalable for the Internet because it is based on IP—any media that can support IP can support Mobile IP.

In IP networks, routing is based on stationary IP addresses, similar to how a postal letter is delivered to the fixed address on the envelope. A device on a network is reachable through normal IP routing by the IP address it is assigned on the network.

As the vehicles of this disclosure are intended to be both mobile and stationary when operating on the network, a vehicle may never have a “home” network, and thus may no longer be reachable using normal IP routing. This results in the active sessions of the device being terminated. Mobile IP enables users to keep the same IP address while traveling to a different network, thus ensuring that a roaming vehicle can continue communication without sessions or connections being dropped.

Because the mobility functions of Mobile IP are performed at the network layer rather than the physical layer, the mobile device can span different types of wireless and wireline networks while maintaining connections and ongoing applications. Remote login, remote printing, and file transfers are some examples of applications where it is undesirable to interrupt communications while an individual roams across network boundaries. Also, certain network services, such as software licenses and access privileges, are based on IP addresses. Changing these IP addresses could compromise the network services.

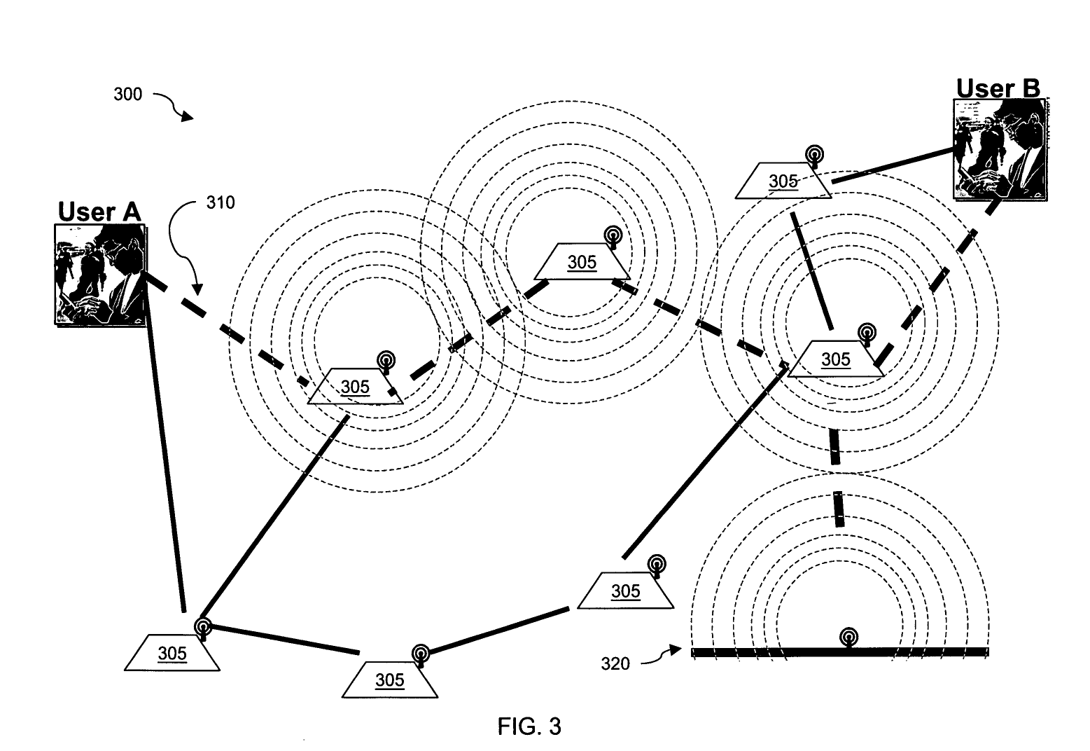

FIG. 3 is a conceptual diagram of a metropolitan mesh network 300 in operation in accordance with this disclosure. In this example, a fleet of vehicles 305 has been equipped with mobile routers as disclosed herein.

It is contemplated that vehicles belonging to a particular organization may be equipped to form a mesh network. For example, vehicles that have related duties, such as freight services, taxi cabs, or emergency vehicles may be wireless-enabled. In such an example, as a fleet of vehicles perform their tasks about a particular area, a virtual canopy of wireless connectivity will be created in the region. As the range of WiMax is approximately 30 miles, and entire city may be provided with wireless connectivity with only a handful of vehicles being on the road at the same time. For example, in the illustration of FIG. 3, User A and User B, connecting through the primary connection path 310 (shown in dashed lines), could be many miles apart.

FIG. 3 shows User A and User B connecting in a peer-to-peer (P2P) fashion through the mobile nodes. As mentioned above, in an ad-hoc network, each mobile node may function as a router, with mesh technology allowing the forwarding of packets by hopping though the swarm of mobile nodes. In a preferred embodiment, each mobile node keeps track of a primary nearest neighbor, and a secondary neighbor. If the primary neighbor drops out of the network, the mobile node establishes the secondary neighbor as the primary contact, and attempts to find a new secondary neighbor. Thus, as long as there is a path from User a to User B, the users will be able to communicate using IP connectivity without the need for a legacy wired network.

Alternatively, connection to the public Internet may be accomplished through an optional WAN 320. Thus, the mobile nodes of this disclosure may also be used to extend the reach of the Internet using the wireless coverage provided by the vehicles of this disclosure, without the need for additional fixed antenna installations.

In a further embodiment, it is contemplated that the vehicles of this disclosure may be equipped with Global Positioning System (GPS) functionality. Coupled with GPS, the vehicles of this disclosure may communicate their locations to a central office. Under control of a central office, waypoints and destination information may be communicated back through the mesh network, allowing the vehicles to self-navigate. On-board vehicle data, such as speed and direction, may be compared with publicly available traffic flow data in real-time to communicate a desired path to vehicles in the fleet, thereby reducing congestion and avoiding trouble areas.

An analysis of on-board data may also reveal the need for maintenance or repairs. Vehicles may automatically schedule maintenance based on on-board analytics, communicating this information through the mesh network to appropriate personnel such as service centers or manufacturers.

It is also contemplated that private vehicles may be configured as mobile nodes. In such an embodiment, GPS functionality may be employed to provided location based services such as finding the nearest gas station, or one with the best price. Accommodations and hotel reservations may be made and verified on-board, thereby optimizing the time spent in a vehicle.

As will now be appreciated, vehicles that have been deployed for a ground-based purpose may now become mobile Wireless Internet Access Providers (WISP) when they are wireless-enabled in accordance with this disclosure. Thus, a company may choose to offer wireless services to the general public and generate additional revenue, such as functioning as an ISP for third-party private subscribers.

It is contemplated that subscriber accounts may be managed by a AAA server (not shown) provided by the WISP. As is known in the art, a AAA Server is a server or servers that provide authentication, authorization and accounting services. These may be co-located with an edge device such as the WAN gateway, or more typically, are located on a separate server and communicate with the edge device's interface via an AAA protocol. The AAA functions may be located on a single server, or may be broken up among multiple servers.

When a private subscriber logs on, the subscriber's profile may be authenticated and the subscriber may then be allowed to access the mesh network and billed accordingly.

Alternatively, subscriber profiles may be “pushed” or uploaded to the vehicles and cached in on-board memory. In such an embodiment, all vehicles in the fleet may function as mini-AAA servers, and can authenticate subscribers in a P2P fashion without accessing a wired network. Profiles may be cached at specified intervals, or as needed. It is contemplated that a target vehicle with updated information may enter the swarm, join the mesh network, and advertise that it has an update, such as a new set of subscriber or service profiles. The updates may be distributed to the peers in the swarm using P2P file sharing techniques. In such a fashion, the fleet of mobile nodes may be updated in a quick and efficient manner.

Subscriber profiles may contain access rules for both private and corporate accounts. For example, private accounts may access general network functionality only, while accounts associated with the vehicles may be provided with additional services and capabilities according to the fleet's overall business.

Therefore, by allowing both private and corporate accounts to function on the mesh network simultaneously, companies can utilize the benefits of the network to improve their own logistics, while generating additional revenue by becoming wireless service providers.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. A metropolitan mesh network comprising:
a plurality of vehicles, each having a mobile router;
the mobile router being configured to form a mesh network with other mobile routers in wireless communication; and
provide peer-to-peer network connectivity for users of the mesh network.

2. The metropolitan mesh network of claim 1, wherein said mobile routers are mobile-IP compliant.

3. The metropolitan mesh network of claim 2, wherein said plurality of mobile vehicles further comprise wireless communication equipment compliant with the IEEE 802.16x specification.

4. The metropolitan mesh network of claim 3, wherein said plurality of mobile vehicles may access the Internet through a wired WAN.

5. The metropolitan mesh network of claim 4, wherein third-party private subscribers may access the Internet through said metropolitan mesh network.

6. The metropolitan mesh network of claim 5, wherein said third party subscribers are charged a fee for accessing said metropolitan mesh network.

7. The metropolitan mesh network of claim 6, wherein said mobile vehicles are further configured authenticate the accounts of said private subscribers.

8. The metropolitan mesh network of claim 3, wherein said mobile vehicles further comprise GPS functionality.

9. The metropolitan mesh network of claim 8, wherein said mobile vehicles communicate their positional information to a central office through said metropolitan mesh network.

10. A metropolitan mesh network comprising:
a plurality of mobile vehicle means;
mobile routing means operatively disposed within each of said mobile vehicle means; and
means for forming a mesh network with other mobile routers in wireless communication.

11. The metropolitan mesh network of claim 10, further comprising means for providing peer-to-peer network connectivity for users of the mesh network.

12. The metropolitan mesh network of claim 11, wherein said mobile routers are mobile-IP compliant.

13. The metropolitan mesh network of claim 12, wherein said plurality of mobile vehicles further comprise wireless communication equipment compliant with the IEEE 802.16x specification.

14. The metropolitan mesh network of claim 13, wherein said plurality of mobile vehicles may access the Internet through a wired WAN.

15. The metropolitan mesh network of claim 14, wherein third-party private subscribers may access the Internet through said metropolitan mesh network.

16. The metropolitan mesh network of claim 15, wherein said third party subscribers are charged a fee for accessing said metropolitan mesh network.

17. The metropolitan mesh network of claim 16, wherein said mobile vehicles are further configured authenticate the accounts of said private subscribers.

18. The metropolitan mesh network of claim 13, wherein said mobile vehicles further comprise GPS functionality.

19. The metropolitan mesh network of claim 18, wherein said mobile vehicles communicate their positional information to a central office through said metropolitan mesh network.

20. A metropolitan mesh network comprising:
a plurality of mobile vehicle means;
mobile routing means operatively disposed within each of said mobile vehicle means; and
means for forming a mesh network with other mobile routers in wireless communication

21. The metropolitan mesh network of claim 20, further comprising means for providing peer-to-peer network connectivity for users of the mesh network.

22. The metropolitan mesh network of claim 21, wherein said mobile routers are mobile-IP compliant.

23. The metropolitan mesh network of claim 22, wherein said plurality of mobile vehicles further comprise wireless communication equipment compliant with the IEEE 802.16x specification.

24. The metropolitan mesh network of claim 23, wherein said plurality of mobile vehicles may access the Internet through a wired WAN.

25. The metropolitan mesh network of claim 24, wherein third-party private subscribers may access the Internet through said metropolitan mesh network.

26. The metropolitan mesh network of claim 25, wherein said third party subscribers are charged a fee for accessing said metropolitan mesh network.

27. The metropolitan mesh network of claim 26, wherein said mobile vehicles are further configured authenticate the accounts of said private subscribers.

28. The metropolitan mesh network of claim 23, wherein said mobile vehicles further comprise GPS functionality.

29. The metropolitan mesh network of claim 28, wherein said mobile vehicles communicate their positional information to a central office through said metropolitan mesh network.

30. A vehicle for participating in a metropolitan mesh network comprising:
a vehicle having a mobile router;
the mobile router being configured to:
form a mesh network with other mobile routers in wireless communication; and
route IP-compliant traffic between members of the mesh network.

31. The metropolitan mesh network of claim 30, wherein said mobile routers provide peer-to-peer network connectivity for users of the mesh network.

32. The metropolitan mesh network of claim 31, wherein said mobile routers are mobile-IP compliant.

33. The metropolitan mesh network of claim 32, wherein said plurality of mobile vehicles further comprise wireless communication equipment compliant with the IEEE 802.16x specification.

34. The metropolitan mesh network of claim 33, wherein said plurality of mobile vehicles may access the Internet through a wired WAN.

35. The metropolitan mesh network of claim 34, wherein third-party private subscribers may access the Internet through said metropolitan mesh network.

36. The metropolitan mesh network of claim 35, wherein said third party subscribers are charged a fee for accessing said metropolitan mesh network.

37. The metropolitan mesh network of claim 36, wherein said mobile vehicles are further configured authenticate the accounts of said private subscribers.

38. The metropolitan mesh network of claim 33, wherein said mobile vehicles further comprise GPS functionality.

39. The metropolitan mesh network of claim 38, wherein said mobile vehicles communicate their positional information to a central office through said metropolitan mesh network.
